(19) United States
(12) Patent Application Publication
(10) Pub. No.: US 2020/0404864 A1
(43) Pub. Date: Dec. 31, 2020

(54) METHOD OF PRODUCING AGARWOOD RESIN

(71) Applicant: Chi-Lin CHANG, Taipei City (TW)

(72) Inventor: Chi-Lin CHANG, Taipei City (TW)

(21) Appl. No.: 16/451,514

(22) Filed: Jun. 25, 2019

(51) Int. Cl. A01G 23/10; C08L 99/00; A01G 7/06

(52) U.S. Cl. CPC A01G 23/10; A01G 7/06; C08L 99/00

(57) ABSTRACT

A method of producing agarwood resin includes: Step (a): forming 4 to 8 first injection holes on an agarwood tree toward a pith of the agarwood tree, wherein each of the first injection holes has a starting end and a terminal end opposite each other, the starting ends of the 4 to 8 first injection holes are evenly distributed around a tree circumference of the agarwood tree, and the terminal ends of the 4 to 8 first injection holes are connected to the xylem of agarwood tree; and Step (b): supplying a gas with a pump into the 4 to 8 first injection holes under pressure to damage the xylem of the agarwood tree in order to produce agarwood resin.

### BACKGROUND OF THE INVENTION

### 1. Field of the Invention

The present invention relates to a method of producing agarwood resin, and particularly a method of producing agarwood resin artificially.

### 2. Description of the Prior Arts

Agarwood is a complex of agarwood resin and xylem of agarwood trees. The main component of the complex comprises Sesquiterpenes, 2-(2-Phenylethyl) chromone, Triterpenoids, Aromatics, and fatty acids. Due to the aforementioned components, agarwood possesses a special aroma and therefore can be extracted for incense. The shade-dried agarwood can be used as Chinese medicine, which has the therapeutic effect of heart and nervous system strengthening. Additionally, the agarwood can be carved for decorations. Due to the numerous uses mentioned above, the agarwood has a fairly high economic value.

For making an agarwood tree produce agarwood, the following conditions must be fulfilled. First, the agarwood tree has to reach a certain age so that the resin glands of the agarwood tree are well-developed in order to largely produce the secretion with a special aroma. Moreover, the agarwood tree has to be knife-cut, be bitten by insects, pass through branch rotting or be infected by microorganism. The aforementioned damages of the agarwood tree induce the production of secretion with a special aroma from resin ligands, which promotes the healing of the damaged tissues. The secretion with a special aroma combined with the xylem is called agarwood. However, the natural progress of agarwood production normally takes about more than 40 years, and the probability of occurrence of the above-mentioned situation is less than 10%. Even an agarwood tree with good resin ligands may produce no agarwood at all throughout its whole life.

Therefore, the naturally-produced agarwood is very rare in the market, and the majority of the agarwood is produced artificially, for example, by damaging the epidermis of an agarwood tree on purpose and preventing wounds from healing, or drilling holes on an agarwood tree, followed by injecting a fungal suspension, which promotes the production of agarwood resin. This makes the agarwood tree infected and further induces the production of the secretion with a special fragrance aroma at the wound or the site of infection, so that the purpose of agarwood production is reached. On the other hand, an agarwood tree with agarwood-resin can be utilized, because they have other commercial value due to the special aroma.

However, regardless of the natural way or artificial way of the agarwood resin production, the agarwood tree only produces the secretion with a special aroma at the site of damage or infection. Therefore, if the massive production of agarwood is desired, the area of damage should be broadened. However, exceeding areas of damages may make the nutrient unable to be transported in the agarwood tree, resulting in the death of agarwood tree. Even though the agarwood tree is able to survive, there is no intact area of the epidermis of agarwood tree after the agarwood is removed, such that the agarwood tree may be unable to be further utilized. Therefore, the method of producing agarwood in the prior art should be improved.

### SUMMARY OF THE INVENTION

To overcome the aforementioned shortcomings, the present invention provides a method of producing agarwood resin, which largely produces agarwood resin without massive damage to the epidermis of the agarwood tree. Therefore, it reduces the probability that the nutrient cannot be transported in the agarwood tree, and further maintains the integrity of the epidermis of the agarwood tree.

To achieve the above purpose, the method of producing agarwood resin of the present invention comprises:

Step (a): forming 4 to 8 first injection holes on an agarwood tree toward a pith of the agarwood tree, wherein each of the first injection holes has a starting end and a terminal end opposite each other, the starting ends of said 4 to 8 first injection holes are evenly distributed around a circumference of the agarwood tree, and the terminal ends of said 4 to 8 first injection holes are connected to xylem of the agarwood tree; and Step (b): supplying a gas with a pump into said 4 to 8 first injection holes under pressure to damage the xylem of the agarwood tree in order to produce agarwood resin.

By the above-mentioned technical means, supplying the gas into the injection holes under pressure in the present invention can damage the xylem of the agarwood tree extensively. Therefore, the agarwood tree is induced to produce the secretion with a special aroma, at the site of damage, in order to produce agarwood resin, which is combined with the xylem to form the agarwood. Due to the distribution method of the injection holes of the present invention, the xylem of the agarwood tree is damaged the most extensively while the epidermis is minimally damaged. Additionally, compared to the method of injecting the fungal suspensions to the injection hole in the prior art, the amount of injection holes can be reduced, thus reducing the area of damage to the appearance of the agarwood tree. Compared to the prior art, the present invention overcomes the problems of poor appearance or death of agarwood tree due to knife cutting. Additionally, the present invention can produce agarwood resin more rapidly, compared to the method of injecting fungal suspension to the injection hole.

Preferably, the starting ends of said 4 to 8 first injection holes are evenly radially distributed on a first cross-section of the agarwood tree.

Preferably, the terminal ends of said 4 to 8 first injection holes are spaced from each other.

Preferably, said 4 to 8 first injection holes are formed from around the circumference of the agarwood tree downward toward the bottom of its pith slopingly. The way of forming the injection holes can prevent nozzles, inserted in the injection holes, from popping-up while supplying a gas with a pump into said 4 to 8 first injection holes under pressure, so that it is easier to supply the gas under pressure. More preferably, the angle between projections of said 4 to 8 first injection holes along their extending directions and the first cross-section is 5° to 60°. More preferably, the angle between the projections of said 4 to 8 first injection holes along the extension directions and the first cross-section is 5° to 25°.

Preferably, the amount of said 4 to 8 first injection holes is an even number. More preferably, the amount of said 4 to 8 injection holes is 6.

Preferably, said 4 to 8 first injection holes comprise at least one deep hole and at least one shallow hole, and said at least one deep hole and said at least one shallow hole are formed alternately. The length of said at least one deep hole and said at least one shallow hole can be adjusted according to the tree diameter. For example, when the tree diameter is 15 cm, the length of said at least one deep hole ranges from greater than 5 cm to 8 cm, and said at least one shallow hole ranges from 2 cm to less than 5 cm. The spaced-apart terminal-ends of said 4 to 8 first injection holes allow the maximal damage to the xylem during gas supply while preventing two opposite deep holes from forming through the trunk of the agarwood tree, thereby reducing the damage to the agarwood tree and increasing the utilization of agarwood tree after the agarwood resin is removed.

More preferably, the deviation value of the angle between projections of said 4 to 8 first injection holes along their extension directions on the first cross-section compared to an ideal angle of their even distribution is within ±5%. The evenly distributed angle means 360° divided by the amount of said 4 to 8 first injection holes, i.e., if there are six first injection holes, the evenly distributed angle is 60°.

Preferably, said step (b) is supplying a gas with a pump by using 15 psi to 30 psi into said 4 to 8 first injection holes to damage the xylem of the agarwood tree in order to produce agarwood resin. This pressure value can achieve the maximal production of agarwood resin and at the same time avoid the explosion of the trunk of the agarwood tree caused by the supplied gas. Preferably, said 4 to 8 first injection holes are spacedly formed 10 cm to 30 cm from the bottom of the trunk of the agarwood tree in a direction away from the root. More preferably, said 4 to 8 first injection holes are 15 cm from the bottom of the trunk of the agarwood tree in a direction away from the root of the trunk of the agarwood tree.

Preferably, besides supplying the gas, the operation in the present invention can be collocated with an injection solution, so that the gas and the injection solution are both supplied into the injection holes to accelerate the production of agarwood resin.

In detail, said step (b) of supplying a gas with a pump by using 15 psi to 30 psi into said 4 to 8 first injection holes under pressure to damage xylem of the agarwood tree in order to produce agarwood resin comprises: supplying a gas with a pump under 15 psi to 30 psi and injecting the injection solution into said 4 to 8 first injection holes to damage the xylem of the agarwood tree in order to produce agarwood resin.

More preferably, the injection solution comprises at least one selected from the group consisting of microorganism, protein, organic acid, and polysaccharides, which induce the production of the agarwood resin.

Preferably, before said step (b), the method further comprises forming a plurality of vents on a tip of the agarwood tree, so that the pressure can be relieved through the vents after gas is supplied. This avoids the explosion of the trunk of the agarwood tree due to extremely high pressure.

Preferably, said Step (a) further comprises: forming 4 to 8 second injection holes on the agarwood tree toward the pith of the agarwood tree, wherein each of the second injection holes has a starting end and a terminal end opposite each other, the starting end of said 4 to 8 second injection holes are evenly distributed around the circumference of the agarwood tree, and the terminal ends of said 4 to 8 second injection holes are connected to the xylem of the agarwood tree; and the Step (b) further comprises: supplying a gas with a pump into said 4 to 8 second injection holes under pressure to damage the xylem of the agarwood tree in order to produce agarwood resin. The second injection holes induces the extent of the damage to the xylem of the agarwood tree in order to produce more agarwood resin.

Preferably, the starting ends of said 4 to 8 second injection holes are evenly radially distributed on a second cross-section of the agarwood tree.

Preferably, the vertical distance between the first cross-section and the second cross-section ranges from 30 cm to 70 cm. More preferably, the vertical distance ranges from 40 cm to 60 cm. More preferably, the vertical distance is 50 cm. This ensures the integrity of the trunk of the agarwood tree between the adjacent first injection holes on the first cross-section and the second injection holes on the second cross-section. This is beneficial to the utilization of the trunk of the agarwood tree.

Preferably, the way of forming said 4 to 8 second injection holes are the same as forming said 4 to 8 first injection holes.

More preferably, 4 to 8 third injection holes and 4 to 8 fourth injection holes can also be formed spacedly from said 4 to 8 first injection holes and 4 to 8 second injection holes depending on the height of the agarwood tree.

Preferably, the diameter of a trunk of the agarwood tree ranges from 15 cm to 30 cm. According to this, said diameter of the agarwood tree collocated with the value of pressure in the present invention ensures that the agarwood tree has well-developed resin ligands, which can largely produce agarwood resin. Said diameter of the trunk further ensures the trunk is able to bear the supplied-pressure and avoid the explosion.

More preferably, the injection solution comprises at least one selected from the group consisting of microorganism, protein, organic acid, and polysaccharides, which induce the production of the agarwood resin. By using the injection solution at the same time, the metabolism of an agarwood tree and growth of microorganism are promoted, so that the production of the secretion with a special aroma from agarwood tree is also induced. This promotes the production of the agarwood resin.

Among others, the microorganism which induces the production of the agarwood resin comprises Fusarium sp., Cladosporium sp., Mucor sp., Penicillium sp., Rhizoplius sp., Trichoderma sp., Schizophyllum sp., Sphamopus sp., and Tolura sp.

Additionally, Chaetomium globosum, Melanotus flavolivens Botryodiplodia theobromae, Ebicoccum granulatum, and Fusarium oxysporum can also induce the production of the agarwood resin.

Said protein comprises vegetable protein and animal protein. Among others, the vegetable protein includes snap pea protein, plant-origin aggregating protein, potato protein, soy protein, and wheat protein. The animal protein includes casein, gelatin protein, beef protein, animal-origin aggregating protein and tryptone.

Preferably, said organic acid includes formic acid and acetic acid.

Preferably, said polysaccharides includes sucrose.

Said agarwood tree generally refers to the tree which can produce agarwood resin, for example, the plant in the Aquilaria family. Among others, the plant in the Aquilaria family further includes plants in the Agallocha genus, Ganadensis genus, Malaccensis genus, Vulgaris genus, Grassna genus, Moskowskii genus, Sinensis genus, and Kajugaru genus.

The term “circumference of the agarwood tree” in the present invention means the imaginary line around the trunk of the agarwood tree.

The term “spaced from each other” in the present invention means without contacting each other.

The term “cross-section” in the present invention means a section plane, which is vertical to the trunk of the agarwood tree and is cross-cut through the agarwood tree.

### BRIEF DESCRIPTION OF THE DRAWINGS

FIG. 1 is a flow chart of the method of producing the agarwood resin of the first embodiment.

FIG. 2 is a schematic side view of a processed agarwood tree of the first embodiment.

FIG. 3 is a schematic top view of a first cross-section of the agarwood tree as shown in FIG. 2.

FIG. 4 is a schematic view of the projection on the first cross-section of the extension direction of the deep holes and the shallow holes of FIG. 3.

FIG. 5 is the schematic side view of the processed agarwood tree of the second embodiment.

FIG. 6 is the schematic top view of first cross-section of the agarwood tree of FIG. 5.

FIG. 7 is the schematic side view of the processed agarwood tree of the third embodiment.

FIG. 8 is the schematic side view of the processed agarwood tree of the fourth embodiment.

### DETAILED DESCRIPTION OF THE PREFERRED EMBODIMENTS

### First Embodiment

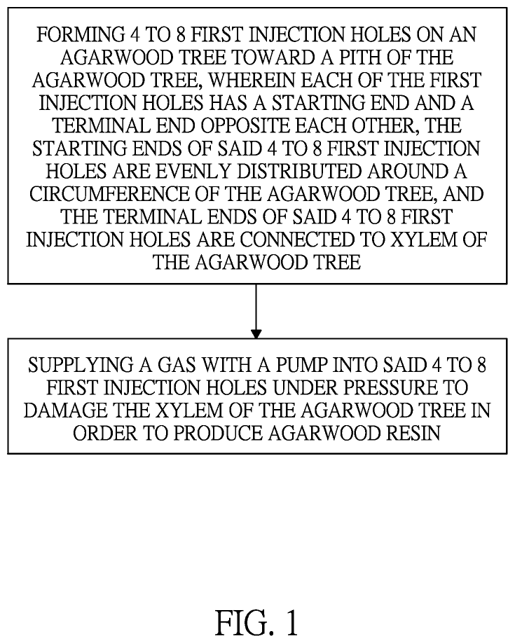

As shown in FIG. 1 to FIG. 4, the first embodiment of the method of producing agarwood resin of the present invention is accomplished in the following steps.

Firstly, as shown in FIG. 1, 4 to 8 first injection holes were formed on an agarwood tree toward its pith. Each of the first injection holes has a starting end and a terminal end opposite each other, the starting ends of said 4 to 8 first injection holes are evenly distributed around the circumference of the agarwood tree, and the terminal ends of said 4 to 8 first injection holes are connected to the xylem of the agarwood tree.

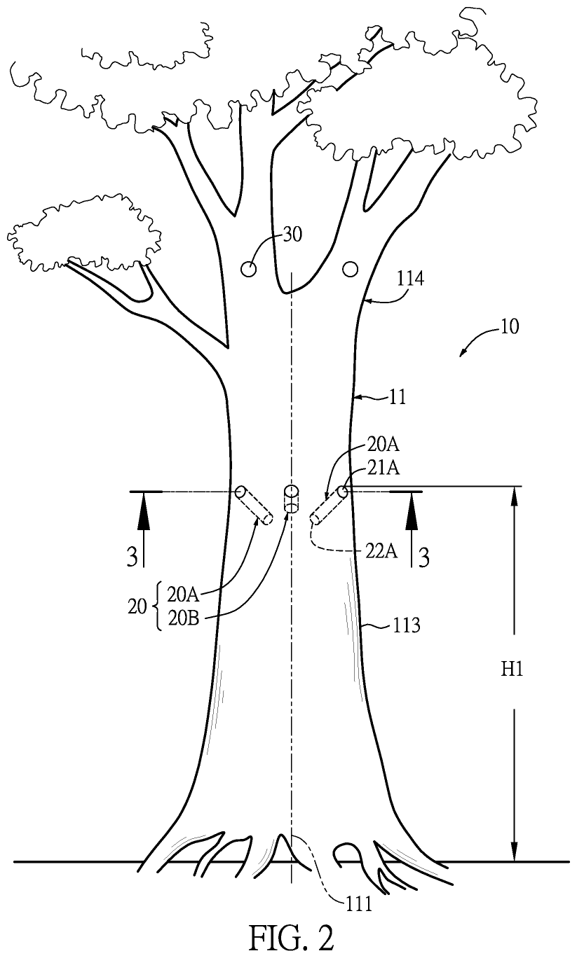

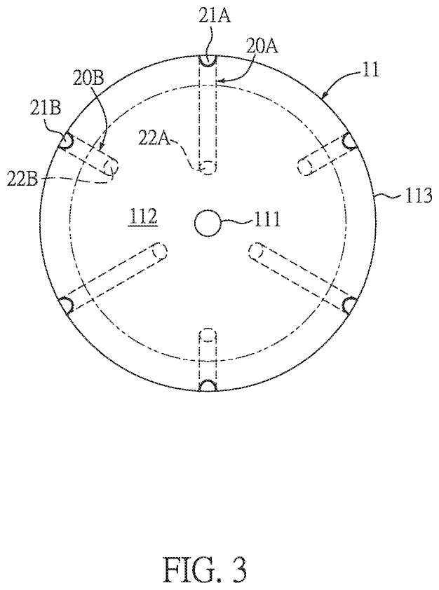

Specifically, as shown in FIG. 2 and FIG. 3, an agarwood tree 10 to be drilled has a trunk 11. The body of the trunk 11 has a pith 111, xylem 112, and a circumference 113 sequentially from the inside out. The top of trunk 11 is a tip 114 of agarwood tree.

Six first injection holes 20 are formed toward the pith 111 of the agarwood tree 10 in evenly radial distribution. The first injection holes 20 are connected to the xylem 112 of the agarwood tree 10. In the present embodiment, said six first injection holes 20 consist of three deep holes 20A and three shallow holes 20B. Each deep hole 20A has a starting end 21A and a terminal end 22A opposite each other, while each shallow hole 20B has a starting end 21B and a terminal end 22B. Said deep holes 20A and shallow holes 20B are formed from around the tree circumference 113 of the agarwood tree 10 downward toward the bottom of its pith 111 slopingly. In this manner, supplying the gas would be easier.

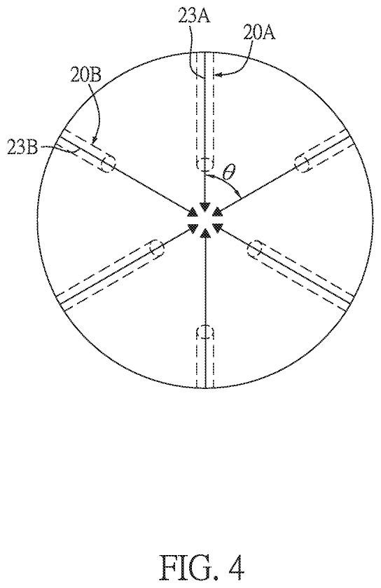

In this embodiment, the starting ends 21A of the three deep holes 20A and the starting ends 21B of the three shallow holes 20B are evenly radially distributed on a first cross-section (as shown in FIG. 3) of the agarwood tree 10. As shown in FIG. 3 and FIG. 4, the deviation value of the angle θ between the projections of the deep holes 20A along their extension directions 23A and of the shallow holes 20B along their extension directions 23B on the first cross-section compared to an ideal angle of their evenly distribution is within ±5%. Said ideal angle means 360° divided by the number, 6, of the first injection holes 20, resulting in 60°. According to this structural design of evenly radial distribution, the amount and the manner of distribution of the injection holes provide the effect of maximal damage of the xylem 112 of the agarwood tree 10 after the gas is supplied, while the tree circumference 113 of the agarwood tree 10 is damaged minimally.

As shown in FIG. 3, the terminal ends 22A of the deep holes 20A and the terminal holes 22B of the shallow holes 20B are connected to the xylem 112 of the agarwood tree 10. The terminal ends 22A of the deep holes 20A and the terminal ends 22B of the shallow holes 20B are spaced from each other without contacting each other. The deep holes 20A and the shallow holes 20B are formed alternately. This reduces the damage of appearance of the agarwood tree 10 and increases the utilization of agarwood tree, after the agarwood resin is removed. The length of deep holes 20A and the shallow holes 20B is adjusted according to the diameter of the agarwood tree 10. In the present embodiment, the length of the deep holes is 6 cm and the length of shallow holes is 3 cm, while the diameter of the agarwood tree 10 is 15 cm.

Besides forming the first injection holes 20 on the trunk 11 of the agarwood tree 10, two vents 30 are further formed on the tip 114 of the agarwood tree 10 in the present invention of the method of producing agarwood resin, in order to reach the purpose of pressure relief through the vents 30. This avoids the explosion of the trunk 11 of the agarwood tree 10 due to extremely high pressure.

Lastly, as shown in FIG. 1, a gas is supplied with a pump under 20 psi into said six first injection holes 20 to damage the xylem 112 of the agarwood tree 10 in order to produce agarwood resin. In the present embodiment, the supplied gas is air. In other implementations, the gas may be, but is not limited to, carbon dioxide, nitrogen, oxygen, argon, or the mixture thereof.

Because the first injection holes 20 and the xylem 112 of the agarwood tree 10 are connected to each other, the xylem 112 of the agarwood tree 10 is stricken by the supplied gas while the gas is supplied into the first injection holes 20 under the pressure by the pump intermittently. In this manner, the xylem 112 is stricken by the force intermittently, and the xylem 112 is damaged, so that the agarwood tree 10 is injured. Since the gas strikes the surrounding parts of the xylem 112 connected to the first injection holes 20 with the same direction after the gas being introduced from the first injection holes 20, the xylem 112 is extensive injured. This is beneficial to promote the production of the secretion, with a special aroma, from the agarwood tree 10, so that the agarwood resin is largely produced by the agarwood tree 10, and the agarwood is further formed by the combination of agarwood resin and xylem from the agarwood tree 10.

In the present embodiment, the first injection holes 20 are formed 15 cm away from the root (which means the surface of the earth) of the trunk 11 of the agarwood tree 10. That is to say, the distance H1 from the surface of the earth to the top of the starting ends 21A of the deep holes 20A or to the top of the starting ends 21B of the shallow holes 20B is 15 cm. Generally, the density of xylem close to the root is higher, while the density of xylem away from the root is lower. Additionally, water is transported upwards by the xylem 112 from the root. Therefore, a fungal suspension fed by injecting is difficult to contact the xylem 112 close to the root, so that the effect of damaging the xylem 112 close to the root is difficult to reach. However, the xylem 112 is extensively damaged in the present invention by supplying the gas under pressure, which would not be effected by the variations of density of the xylem 112 and the transportation direction of the xylem.

In other implementations, the injection solution can be collocated together while supplying the gas into the first injection holes 20 under pressure, so that the effect of damaging the xylem 112 fiber and increasing the area of injection solution in contact with the xylem 112 fiber are both reached at the same time. The injection solution would contact the xylem 112 close to the pith 111, because the flowing direction of the injection solution is toward to the pith 111 after induction. Furthermore, the water is transported by the xylem 112 upwards from the root. Therefore, the majority of the injection solution would go upper along the water-transported direction and extensively contact the xylem 112, so that the agarwood resin is produced massively. The injection solution is prepared in accordance with the prior art. Among others, the injection solution comprises water, peptone, yeast extract, Melanotus flavolivens, Botryodiplodia theobromae, acetic acid, and sucrose. The injection solution can induce the production of secretion with a special aroma from the agarwood tree 10 and the production of the agarwood resin.

The foregoing mentioned peptone is produced by the hydrolysis of vegetables, grains and root vegetables, milk and meat by enzyme. Among others, it includes peptide, free amino acid, mineral, vitamin, and essential growth factor for microorganism, which can provide the nutrition for supporting the survival of microorganism.

### Second Embodiment

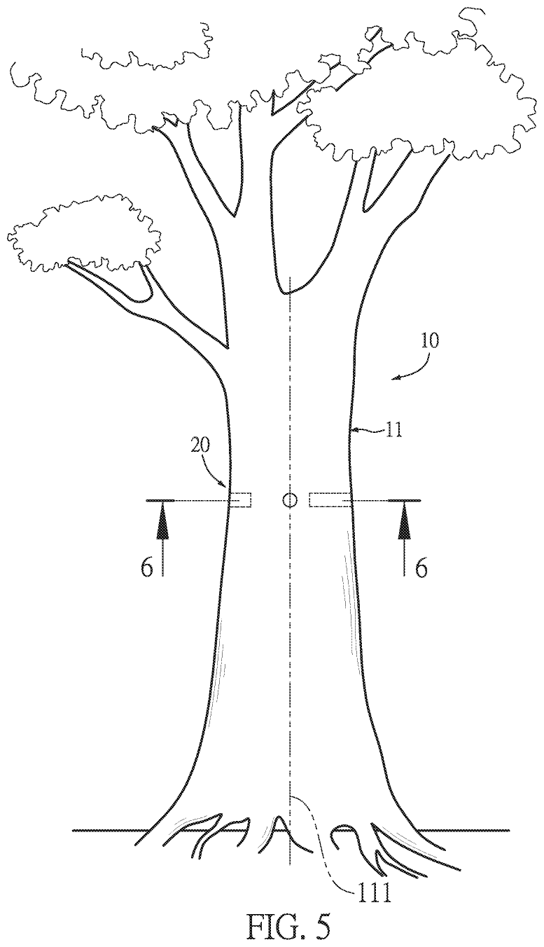

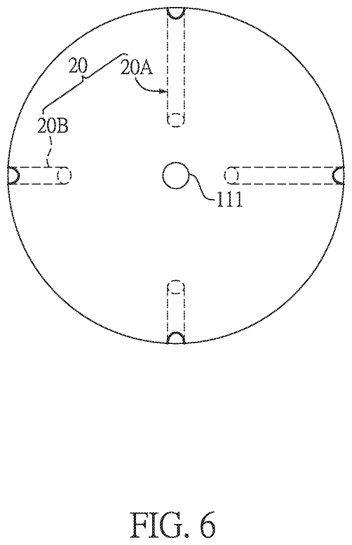

As shown in FIG. 5 and FIG. 6, the second embodiment is similar to the first embodiment. However, the amount of the first injection holes 20 is adjusted to four. Said four first injection holes 20 are formed perpendicular to the pith 111 of the agarwood tree 10. Said four first injection holes 20 consist of two deep holes 20A and two shallow holes 20B. Additionally, as shown in FIG. 6, said deep holes 20A and the shallow holes 20B are not formed alternately but distributed as two adjacent deep holes 20A and two adjacent shallow holes 20B.

### Third Embodiment

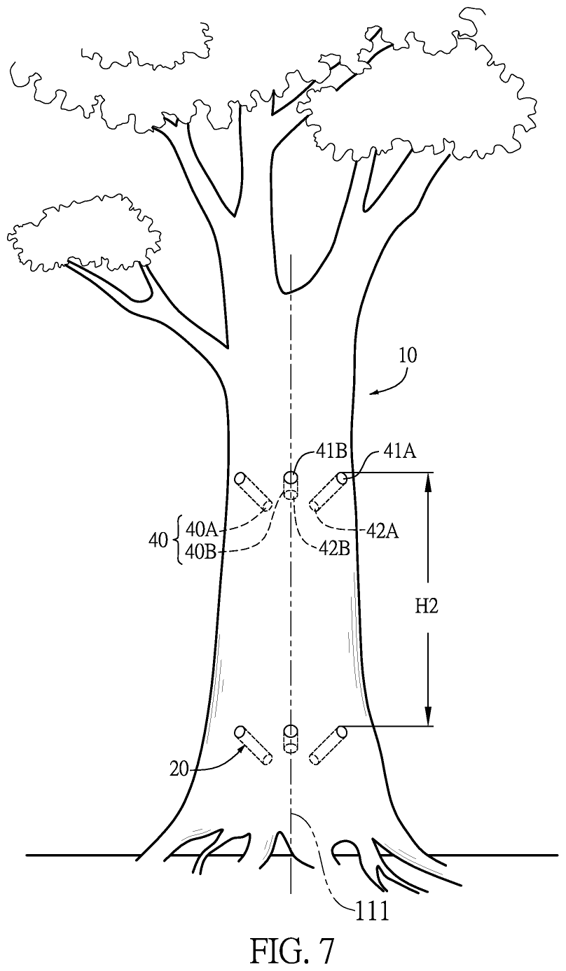

As shown in FIG. 7, the third embodiment is similar to the first embodiment. The difference is described as follows. Besides the six first injection holes 20 on the agarwood tree 10, there are second injection holes 40 formed on the agarwood tree 10 toward the pith 111. Said second injection holes 40 are connected to the xylem of the agarwood tree 10. In the present embodiment, the construction of said six second injection holes 40 are almost the same as the six first injection holes in the first embodiment, and said six second injection holes 40 consist of three deep holes 40A and three shallow holes 40B. Each deep hole 40A has a starting end 41A and a terminal end 42A, while each shallow hole 40B has a starting end 41B and a terminal end 42B. Said deep holes 40A and the shallow holes 40B are formed from around the tree circumference 113 of the agarwood tree 10 downward toward the bottom of pith 111 slopingly. In this manner, supplying the gas would be easier. Forming the second injection holes 40 induces the extent of the damage to the xylem of the agarwood tree 10 in order to produce more agarwood resin.

Said six second injection holes 40 and said six first injection holes 20 are formed spacedly. The starting ends 41 A and 41B of said six second injection holes 40 are evenly radially distributed around the tree circumference on the second cross-section of the agarwood tree 10. The vertical distance H2 between the first cross-section and the second cross-section is 50 cm. This ensures the integrity of the agarwood tree 10 between the adjacent first injection holes 20 on the first cross-section and the second injection holes 40 on the second cross-section. Said the terminal ends 42A and 42B of said six second injection holes 40 are connected to the xylem of the agarwood tree 10. In another implementation, third injection holes and fourth injection holes are formed according to the height of the tree, in order to produce the agarwood resin maximally. Additionally, in Step (b), a gas is not only supplied into said six first injection holes 20 under pressure with a pump, but also supplied into said six second injection holes 40 under pressure with a pump, in order to produce more agarwood resin due to the increased damage of the xylem of the agarwood tree 10.

### Fourth Embodiment

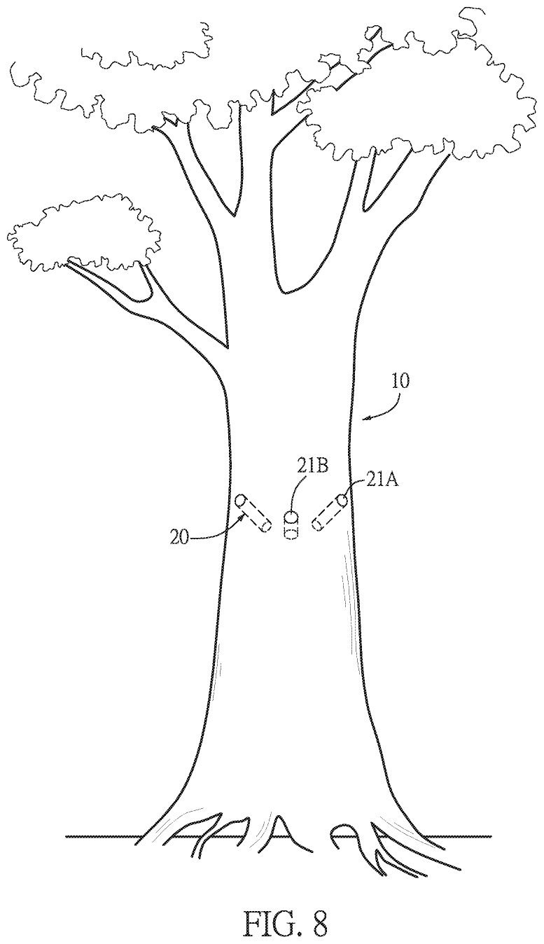

As shown in FIG. 8, the fourth embodiment is similar to the first embodiment. Said six first injection holes 20 are formed on the agarwood tree 10 in evenly radial distribution. Namely, the deviation value of the angle between the projections of the six first injection holes 20 along their extension directions on the first cross-section compared to an ideal angle, which is 60°, of their evenly distribution is within ±5%. The difference is that the starting ends 21A and 21B of the first injection holes 20 are not on the same cross-section.

In conclusion, through supplying the gas under pressure in order to damage the xylem of the agarwood tree, not only the xylem fiber of the agarwood is extensively damaged, but also the integrity of appearance of agarwood tree is preserved. This overcomes the problems of poor appearance or death of agarwood tree due to the knife cutting in the prior art. The present invention can also produce agarwood resin more rapidly compared to the method of injecting fungal suspension to the injection hole. The operation in the present invention can be collocated with an injection solution to accelerate the production of agarwood resin.

It is apparent to those skilled in the art that various modifications and variations can be made without departing from the scope and spirit of the invention. Although the present invention has been described in terms of specific preferred embodiments, it should be understood that the invention should not be unduly limited to those specific embodiments. In fact, the various modifications that are obvious to those of ordinary skill in the art are also encompassed within the scope of the following claims.

What is claimed is:

1. A method of producing agarwood resin, comprising:
Step (a): forming 4 to 8 first injection holes on an agarwood tree toward a pith of the agarwood tree, wherein each of the first injection holes has a starting end and a terminal end opposite each other, the starting ends of said 4 to 8 first injection holes are evenly distributed around a circumference of the agarwood tree, and the terminal ends of said 4 to 8 first injection holes are connected to xylem of the agarwood tree; and
Step (b): supplying a gas with a pump into said 4 to 8 first injection holes under pressure to damage the xylem of the agarwood tree in order to produce agarwood resin.

2. The method according to claim 1, wherein the starting ends of said 4 to 8 first injection holes are evenly radially distributed on a first cross-section of the agarwood tree, wherein the terminal ends of said 4 to 8 first injection holes are spaced from each other.

3. The method according to claim 1, wherein said 4 to 8 first injection holes are formed from around the circumference of the agarwood tree downward toward the bottom of the pith slopingly.

4. The method according to claim 1, wherein said Step (a) further comprises: forming 4 to 8 second injection holes on the agarwood tree toward the pith of the agarwood tree, wherein each of the second injection holes has a starting end and a terminal end opposite each other, the starting end of said 4 to 8 second injection holes are evenly distributed around the circumference of the agarwood tree, and the terminal ends of said 4 to 8 second injection holes are connected to the xylem of the agarwood tree; and the Step (b) further comprises: supplying a gas with a pump into said 4 to 8 second injection holes under pressure to damage the xylem of the agarwood tree in order to produce agarwood resin.

5. The method according to claim 4, wherein the starting ends of said 4 to 8 second injection holes are evenly radially distributed on a second cross-section of the agarwood tree.

6. The method according to claim 5, wherein the amount of said 4 to 8 injection holes is 6.

7. The method according to claim 2, wherein said 4 to 8 first injection holes comprise at least one deep hole and at least one shallow hole, and said at least one deep hole and said at least one shallow hole are formed alternately.

8. The method according to claim 1, wherein the deviation value of the angle between projections of said 4 to 8 first injection holes along their extension direction on the first cross-section compared to an ideal angle of their evenly distribution is within ±5%, said ideal angle is obtained by dividing 360° by the amount of said 4 to 8 first injection holes.

9. The method according to claim 2, wherein the deviation value of the angle between projections of said 4 to 8 first injection holes along their extension direction on the first cross-section compared to an ideal angle of their evenly distribution is within ±5%, said ideal angle is obtained by dividing 360° by the amount of said 4 to 8 first injection holes.

10. The method according to claim 3, wherein the deviation value of the angle between projections of said 4 to 8 first injection holes along their extension direction on the first cross-section compared to an ideal angle of their evenly distribution is less than ±5%, said ideal angle is obtained by dividing 360° by the amount of said 4 to 8 first injection holes.

11. The method according to claim 4, wherein the deviation value of the angle between projections of said 4 to 8 first injection holes along their extension direction on the first cross-section compared to an ideal angle of their evenly distribution is within ±5%, said ideal angle is obtained by dividing 360° by the amount of said 4 to 8 first injection holes.

12. The method according to claim 5, wherein the deviation value of the angle between projections of said 4 to 8 first injection holes along their extension direction on the first cross-section compared to an ideal angle of their evenly distribution is within ±5%, said ideal angle is obtained by dividing 360° by the amount of said 4 to 8 first injection holes.

13. The method according to claim 6, wherein the deviation value of the angle between projections of said 4 to 8 first injection holes along their extension direction on the first cross-section compared to an ideal angle of their evenly distribution is within ±5%, said ideal angle is obtained by dividing 360° by the amount of said 4 to 8 first injection holes.

14. The method according to claim 7, wherein the deviation value of the angle between projections of said 4 to 8 first injection holes along their extension direction on the first cross-section compared to an ideal angle of their evenly distribution is within ±5%, said ideal angle is obtained by dividing 360° by the amount of said 4 to 8 first injection holes.

15. The method according to claim 8, wherein said Step (b) is supplying the gas with the pump by using 15 psi to 30 psi into said 4 to 8 first injection holes under pressure to damage the xylem of the agarwood tree in order to produce agarwood resin.

16. The method according to claim 13, wherein said Step (b) is supplying the gas with the pump by using 15 psi to 30 psi into said 4 to 8 first injection holes under pressure to damage the xylem of the agarwood tree in order to produce agarwood resin.

17. The method according to claim 14, wherein said Step (b) is supplying the gas with the pump by using 15 psi to 30 psi into said 4 to 8 first injection holes under pressure to damage the xylem of the agarwood tree in order to produce agarwood resin.

18. The method according to claim 15, wherein before said Step (b), the method further comprises forming vents on a tip of the agarwood tree.

19. The method according to claim 16, wherein before said Step (b), the method further comprises forming vents on a tip of the agarwood tree.

20. The method according to claim 17, wherein before said Step (b), the method further comprises forming vents on a tip of the agarwood tree.
